(19) United States
(12) Patent Application Publication
(10) Pub. No.: US 2010/0229746 A1
(43) Pub. Date: Sep. 16, 2010

(54) METHOD AND APPARATUS FOR DEDUSTING A SUCTION SYSTEM FOR A ROTARY PRESS

(75) Inventors: Stefan Luedemann, Hamburg (DE); Hans Wolf, Schwarzenbek (DE)

Correspondence Address: VIDAS, ARRETT & STEINKRAUS, P.A., SUITE 400, 6640 SHADY OAK ROAD, EDEN PRAIRIE, MN, 55344, US

(73) Assignee: Fette GmbH, Schwarzenbek (DE)

(21) Appl. No.: 12/715,817

(22) Filed: Mar. 2, 2010

(30) Foreign Application Priority Data
Mar. 14, 2009 (DE) 10 2009 013 180.9

(51) Int. Cl. B41L 41/00

(52) U.S. Cl. 101/425

(57) ABSTRACT

A method for dedusting a suction system for rotary presses, wherein the cleaning liquid is guided into the suction system, and wherein the suction system is closed in the region of the press room of the press, and at least a part of the suction system is flooded with cleaning liquid, and the cleaning liquid is subsequently drained into the press room.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

With tablet presses, it is known to remove the dust that is generated in the press room via a suitable suction system. Such a suction system contains in most cases several suction nozzles, which are placed at suitable locations in the press room. The suction lines are connected to a suction apparatus outside the press room via a collecting line. It is necessary to clean the suction system from time to time with a cleaning medium, for instance with water.

It is known to associate cleaning nozzles to the suction system or its channel- or line system, respectively, which are provided with cleaning medium via a line. The greater the number of cleaning nozzles, the better the cleaning result. However, such a cleaning apparatus has some disadvantages. Due to their way of function, the cleaning nozzles do not have a uniform cleaning effect, and in most cases there are spraying shadows in which no dedusting takes place. The action range of cleaning nozzles is limited. This results either in a very high number of cleaning nozzles, or in a worse cleaning result. The expense for the supply of the cleaning nozzles with cleaning medium is naturally increasing with the number of the cleaning nozzles.

A further disadvantage of the known cleaning system is the constructive space that is needed for the cleaning components, which is relatively great. Even the expense for a plurality of cleaning nozzles and corresponding supply lines is high. Moreover, the cleaning nozzles make the cross section of the line narrow and may lead to clogging of the pipeline. Cleaning nozzles cause unevenness in the inner wall surface of lines, and therefore they pose a cleaning problem on their part. Finally, it is not possible to arrange cleaning nozzles at every arbitrary position of the suction system.

Therefore, the present invention is based on the objective to provide a method and an apparatus for safe and complete cleaning of the suction system in rotary presses.

### BRIEF SUMMARY OF THE INVENTION

In the method of the present invention, at least a part of the suction system is flooded with cleaning liquid. The cleaning liquid is subsequently drained into the press room and removed from the same. In the apparatus of the present invention, cut-off valves are disposed in the suction lines for this purpose, which can be selectively closed with the aid of a suitable control device. When these cut-off valves are closed, the cleaning medium which is supplied via a port is dammed up in the suction system. When a predetermined level is reached in one embodiment of the present invention by doing so, the supply of cleaning medium is stopped. The cut-off valves can be subsequently opened in arbitrary order and for arbitrary duration, so that a flow is formed in the suction system. By opening and closing the cut-off valves in a clockwise manner, high flow velocities and turbulences are generated even in the regions below the cut-off valves, which provide that a good dedusting takes place even below the cut-off valves. By excitation of the cleaning liquid with ultrasound, the cleaning action can be improved still more in a further embodiment of the present invention.

It is to be understood that a closing valve is also arranged in the port for cleaning liquid, which is actuated by the control device. It is opened only when a cleaning is intended. However, before opening the same, the cut-off valves in the suction lines must be closed.

With the aid of the present invention, a selective dedusting of one or several strings of the suction system can be achieved by corresponding connection of the cut-off valves. As already mentioned, the use of ultrasound supports the dedusting.

With the aid of the present invention, a reliable dedusting of all the surfaces of the suction system for tablet presses is achieved. A high dedusting efficiency can be achieved by high flow velocities and turbulences in the flow of the cleaning medium. The apparatus of the present invention needs only a small constructional space, because no cleaning nozzles and no individual supply lines to the nozzles are necessary. The expense for cleaning nozzles and corresponding lines is avoided. Compared to this, the additional expense for the cut-off valves in the suction lines and the corresponding control device for the same is kept in narrow limits.

### BRIEF DESCRIPTION OF EACH OF THE FIGURES OF THE DRAWINGS

The present invention is explained in more detail by means of drawings in the following.

FIG. 1 shows in a very schematic depiction a suction system for a tablet press according to the present invention during the suction operation.

FIG. 2 shows the suction system of FIG. 1 during cleaning.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

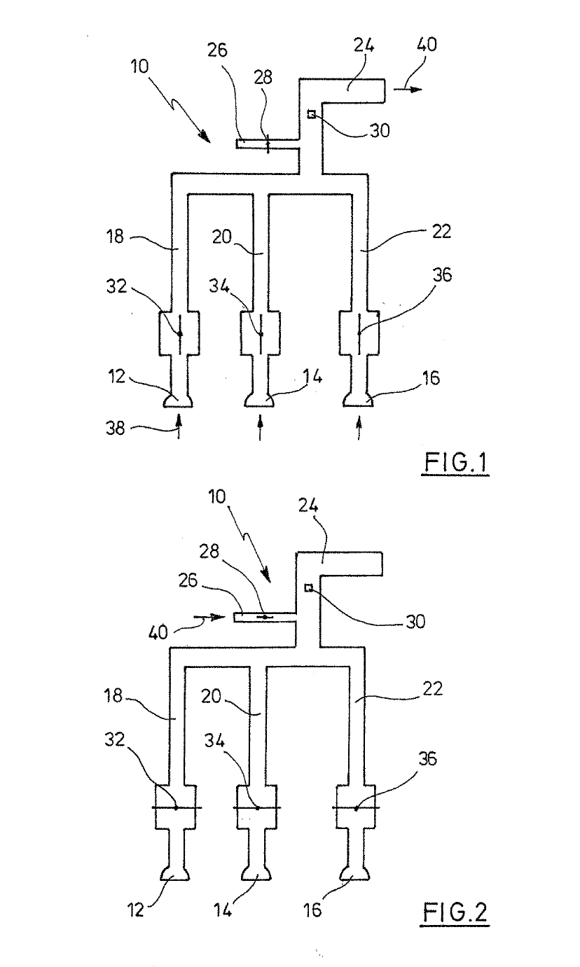

In FIGS. 1 and 2, a suction system designated with 10 is shown, with whose aid dust and contaminations can be removed from a not shown press chamber of a rotary press. Neither a rotary press nor an aggregate for the suction is shown in the figures. One recognises only three suction nozzles 12, 14, 16, which are disposed at suitable locations in the press room. The suction nozzles 12 to 16 are connected to suction lines 18, 20, 22, which on their part are guided to a collecting line 24. A supply line 26 for cleaning liquid is connected to the collecting line, in which a closing valve 28 is arranged. At the downstream side of the supply line 26, a filling level sensor 30 is disposed in the collecting line 24.

Cut-off valves 32, 34, 36 are associated to the suction lines 18 to 22. The valves 28 and 32 to 36 are actuated by a suitable not shown control device of the tablet press. The filling level sensor 30 is also connected to the control device.

During the operation of the press, a suction pressure is generated on the collecting line 24, and a suitable suction aggregate aspirates the atmosphere from the press room. This is indicated by arrows 38 and 40, respectively. Such a suction operation is commonly known for tablet presses. The cut-off valves 32 to 36, which may be formed by suitable flaps, are opened in this. The closing valve 28 is closed, however. When cleaning the suction system is intended to take place, the cut-off valves 32 to 36 are closed, as depicted in FIG. 2. The closing valve 28 is opened. Through this, cleaning liquid can enter into the suction system according to arrow 40. That is to say, the suction lines 18 to 22 above the cut-off valves 32 to 36 are flooded through this. Flooding is stopped as soon as the cleaning liquid has reached the filling level sensor 30. The same outputs a signal to the not shown control device, which subsequently closes the closing valve 28 and stops the further supply of cleaning liquid by doing so. Instead of a level sensor, a clock relay may be provided also, which closes the closing valve 28 again after a certain time after the opening. The suction aggregate is cut off during the flooding process. In order to remove the cleaning liquid, the cut-off valves 32 to 36 are opened simultaneously or one after the other. The cleaning liquid flows downward into the press room and cleans the lines 18 to 22 below the cut-off valves 32 to 36. The cleaning liquid that has flown into the press room is removed from the press room in the usual manner.

It is also possible to open and to close the cut-off valves 32 to 36 in a clocked manner, in order to achieve a suitable flow velocity and turbulence even below the cut-off valves, by which the cleaning efficiency is improved. By excitation of the cleaning liquid with ultrasound (not shown), a further improvement of the cleaning efficiency is achieved.

The cut-off valves 32 to 36 can be formed by so-called squeeze valves. Squeeze valves are per se state of the art. In the same, a flexible region of a line is more or less constricted with the aid of a suitable means in order to limit or to cut off the flow, respectively.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

What is claimed is:

1. A method for dedusting a suction system for rotary presses, wherein cleaning liquid is guided into the suction system, characterised in that the suction system is closed in the region of the press room of the press, and at least a part of the suction system is flooded with cleaning liquid, and the cleaning liquid is subsequently drained into the press room.

2. A method according to claim 1, characterised in that flooding with cleaning liquid is stopped when the level of the cleaning liquid in the suction system has reached a predetermined value.

3. A method according to claim 1, characterised in that the cleaning liquid in the suction system is excited by ultrasound.

4. An apparatus for dedusting a suction system for rotary presses, wherein at least one suction nozzle within a press room is/are connected to a suction apparatus outside the press room via a suction line and a collecting line, characterised in that the suction line (18 to 22) has a cut-off valve (32 to 36), the collecting line (24) is connectable to a cleaning line (26) to which a controllable closing valve (28) is associated, and that a control device for the actuation of the cut-off valve (32 to 36) and of the closing valve (28) is provided, which sets the cut-off valve (32 to 36) into the cut-off position when the closing valve (28) is opened.

5. An apparatus according to claim 4, characterised in that the cut-off valve (32 to 36) is arranged in the vicinity of the suction nozzles (12 to 16).

6. An apparatus according to claim 4, characterised in that a filling level sensor (30) is associated to the collecting line (24) which is connected to the control device, and that the control device closes the closing valve when the liquid level reaches the filling level sensor (30).

7. An apparatus according to claim 4, characterised in that the control device drives the cut-off valve (32 to 36) in a clocked manner, in order to open and close it periodically.
